(19) United States
(12) Patent Application Publication
(10) Pub. No.: US 2008/0106020 A1
(43) Pub. Date: May 8, 2008

(54) Bench top manipulator for small components

(75) Inventor: Graham D. Sherlock, Greenville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/591,566

(22) Filed: Nov. 2, 2006

(51) Int. Cl. B25B 5/14

(52) U.S. Cl. 269/71; 269/81; 269/75; 269/76

(57) ABSTRACT

A bench-top workpiece holder comprising: a bench clamp for attaching the workpiece holder to a bench top; and an articulated arm assembly supported on a post extending vertically upwardly from the clamp, the arm assembly mounting a workpiece clamp assembly for selectively pivotable movement about three substantially parallel vertical axes and for rotation about a substantially horizontal axis.

This invention relates to bench-top work holders and, more specifically, to an articulated bench top workpiece manipulator that can support a workpiece or component and position it in any desired manner to enable, for example, the application of braze-paste in a brazing process and can also be used for welding, soldering, gluing, grinding, etc.

### BACKGROUND OF THE INVENTION

It has proven difficult to support certain relatively small turbine components, for example, a stage one inner shroud tile, in order to apply braze-paste to the tile without either damaging the tile or the newly-applied braze paste or dropping it. Repeated holding or manipulating of the component can create strain in the operator's arms, hands and shoulders, and thereby increase the probability of accidentally damaging the component or of causing repetitive strain injuries to the operator. While certain bench-top devices for holding a workpiece exist, the inventor is not aware of any that have all of the required pivot axes to permit the desired degree of positioning and manipulation of the workpiece for the operations of interest.

### BRIEF DESCRIPTION OF THE INVENTION

A bench-top manipulator is provided in an exemplary and non-limiting embodiment that incorporates a workpiece clamp and that can be positioned via pivoting movement of a pair of support arms about multiple vertical axes, with the clamp itself also rotatable about a horizontal axis. In the exemplary embodiment, the manipulator includes a bench clamp by which the device can be securely fixed to a work bench or the like. A fixed post extends vertically upwardly from one end of the bench clamp and serves to support a first horizontal swing arm that is mounted for adjustable vertical movement along the post as well as for pivoting motion about the post. A second swing arm is pivotally secured to the first swing arm for pivotal movement about a second axis parallel to the post, and at the remote end of the second swing arm, there is mounted a clamp block assembly that is able to pivot about a third vertical axis and to also rotate about a horizontal axis. The workpiece clamp includes a clamping screw for securely holding the workpiece within the clamp block.

Accordingly, in one exemplary embodiment, there is provided a bench-top workpiece holder comprising: a bench clamp for attaching the workpiece holder to a bench top; and an articulated arm assembly supported on a post extending vertically upwardly from the clamp, the arm assembly mounting a workpiece clamp assembly for selectively pivotable movement about three substantially parallel vertical axes and for rotation about a substantially horizontal axis.

In another aspect, there is provided a bench-top workpiece holder comprising: a bench clamp comprising a pair of vertically spaced, substantially parallel plates and a clamp screw for attaching the workpiece holder to a bench top; and an articulated arm assembly supported on a post extending vertically upwardly from the bench clamp, the articulated arm assembly comprising a first swing arm pivotably mounted on the post and vertically adjustable along the height of the post, a second swing arm pivotably mounted to a remote end of the first swing arm and a workpiece clamp assembly selectively pivotable about three substantially parallel vertical axes and rotatable about a substantially horizontal axis; wherein the workpiece clamp assembly comprises a block pivotably secured to a remote end of the second swing arm, and a forked clamp member supported on the block for rotation about the horizontal axis.

The invention will now be described in detail in connection with the drawings identified below.

### BRIEF DESCRIPTION OF THE DRAWINGS

FIG. 1 is a side elevation of an exemplary bench top manipulator in accordance with the invention;

FIG. 2 is a top plan view of the bench top manipulator shown in FIG. 1; and

FIG. 3 is a partial perspective view of the workpiece clamp block assembly illustrated in FIGS. 1 and 2.

### DETAILED DESCRIPTION OF THE INVENTION

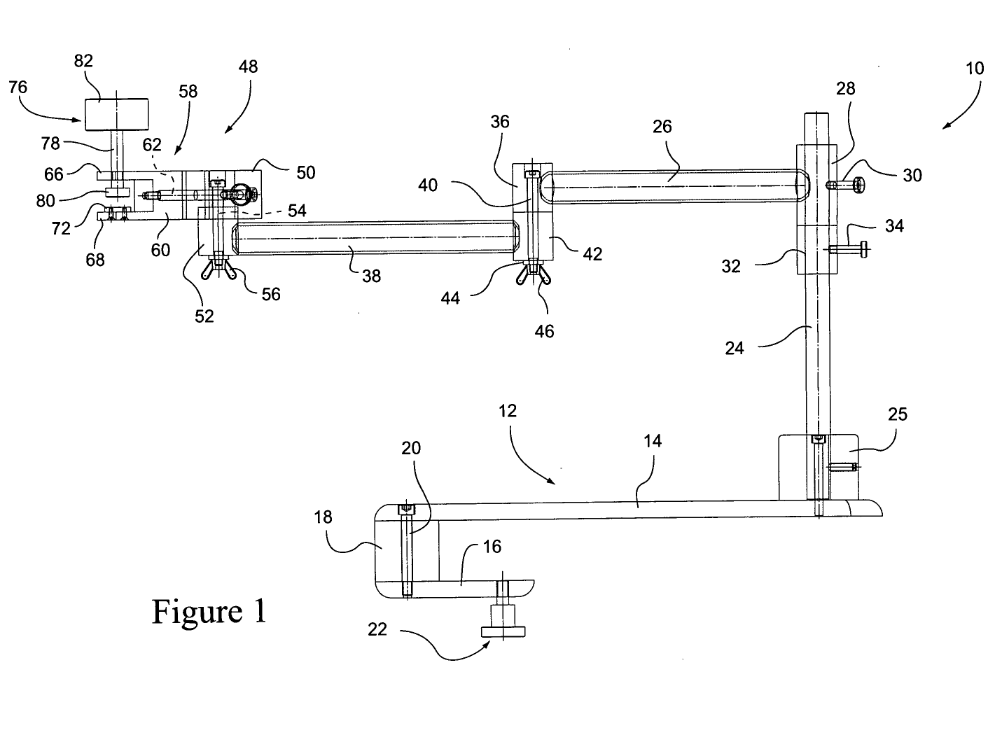

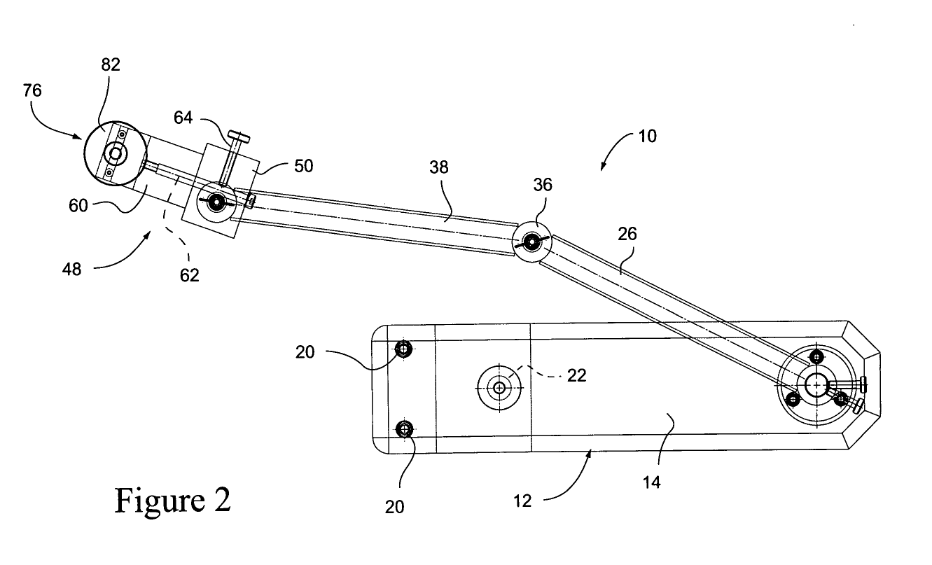

With reference to FIGS. 1 and 2, the bench-mounted workpiece manipulator 10 comprises a bench clamp 12 that includes a first relatively longer flat plate 14 and a second relatively shorter flat plate 16. The plates 14 and 16 are parallel and are joined at one end by a spacer block 18 via screws 20. It will be appreciated that the thickness of the block 18 will correspond generally to the thickness of a bench top, recognizing that the block 18 may be replaced by blocks of other thicknesses, depending on the thickness of the bench top. A screw clamp 22 extends through the second plate 16 and serves to fixedly secure the bench top manipulator to the bench.

A post 24 extends upwardly from an end of the plate 14 remote from the spacer block 18. The post 24 is secured in a base 25 by any suitable arrangement, and may have length of about twelve inches and serves to support a first horizontal swing arm 26 that is slidably and pivotally mounted on the post. Note that the arm 26 is provided with a sleeve or bushing 28 that telescopes over the post, with a set or locking screw 30 (or other suitable clamping device) fixing the arm at a desired angle relative to the plate 14. Thus, the post 24 serves as a first pivot axis for adjustably positioning the workpiece holder described further herein. In addition, an optional locking sleeve 32, also provided with a set or locking screw 34, may be employed, if desired, to reinforce the holding force supplied by the set screw 30 with respect to the vertical location of the bushing 28.

At the end of swing arm 26 remote from the post 24, a bushing 36 is fixed to the arm 26 and serves to mount a second horizontal swing arm 38. More specifically, a threaded shank 40 extends through bushing 36 and a bushing or sleeve 42 fixed at one end of the arm 38. The sleeve 42 (and thus the swing arm 38) is secured to the bushing 36 via washer or spacer 44 and a wing type lock nut 46. With this arrangement, the second swing arm 38 is able to pivot about the shank 40 which serves as a second vertical pivot axis.

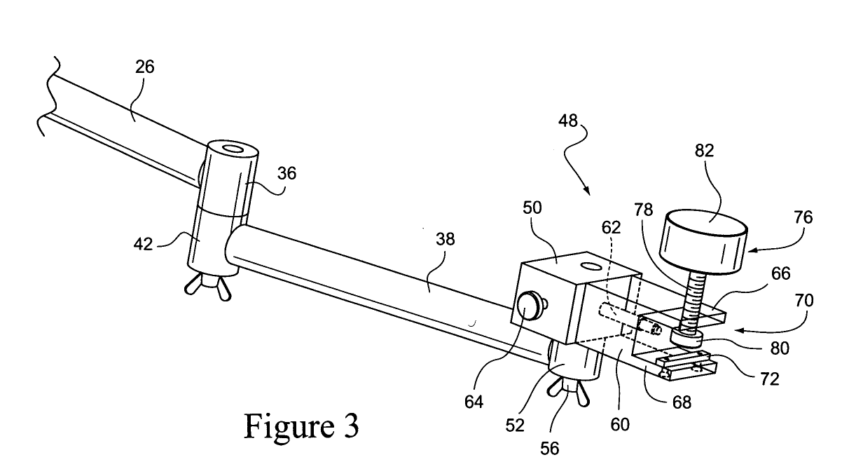

The remote end of the second swing arm 38 mounts a clamp block assembly 48. With reference now also to FIG. 3, the clamp block assembly includes a block 50 that is pivotally secured to the second swing arm 38 by means of a third bushing 52 and a threaded shank 54 (FIG. 1) that extends through the block 50 and bushing 52, secured by wing nut 56 in substantially the same manner as described above in connection with bushing 36 and sleeve 42. Thus, shank 54 serves as a third vertical pivot axis. The block 50 mounts a workpiece clamp assembly 58. The assembly 58 includes a forked clamp member 60 that is rotatably secured to the block 50 by means of a threaded shank 62, thus permitting the clamp 60 to rotate about a horizontal axis, perpendicular to the shank 54. The clamp 60 can be locked in the desired rotational position by means of a set or locking screw 64 that extends horizontally through the block 50 as best seen in FIGS. 2 and 3.

The clamp 60 includes a pair of arms 66, 68 defining a workpiece or component holding recess 70, with the arm 68 provided with a workpiece support block 72. Opposed to the block 72, there is a screw clamp 76 that includes a threaded shank 78 extending through the clamp arm 66, with a clamp block 80 attached at the free end of the shank 78. An enlarged head 82 facilitates rotation of the shank 78 such that the workpiece or component is securely clamped between the block 80 and the support 72.

With this arrangement, the articulated work bench manipulator provides for adjustable pivoting action of swing arms 26, 38 and clamp block assembly 48 about no fewer than three vertical axes defined by post 24, shank 40, and shank 54, while at the same time, the workpiece clamp assembly 58 is also free to rotate about a horizontal axis defined by shank 62 thus providing multiple degrees of freedom for accurately positioning a component or workpiece held between the clamp block 80 and workpiece support block 72 as already indicated, the swing arms and hence the workpiece clamp block assembly 48 are also adjustable vertically along the post 24.

It will be appreciated that the dimensions of the various components may be varied depending on specific applications, workpiece sizes and the like. Other suitable pivot mechanisms for the swing arms 26, 38 and workpiece clamp block 50 and clamp assembly 58 could also be utilized in place of sleeve 28 and threaded shanks 40, 54 and 62.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A bench-top workpiece holder comprising:
a bench clamp for attaching the workpiece holder to a bench top; and
an articulated arm assembly supported on a post extending vertically upwardly from said clamp, said arm assembly mounting a workpiece clamp for selective adjustable pivotable movement about three substantially parallel vertical axes and for rotation about a substantially horizontal axis wherein said articulated arm assembly includes a first substantially horizontal swing arm pivotably mounted on said post for movement about a first of said three parallel vertical axes and vertically adjustable along the height of said post, a second substantially horizontal swing arm pivotably mounted to a remote end of said first swing arm for movement about a second of said three parallel vertical axes; wherein said workpiece clamp forms part of a clamp block assembly that comprises a block pivotably secured to a remote end of said second swing arm for movement about a third of said three parallel vertical axes, and a forked clamp member supported on said block for rotation about said horizontal axis, and further wherein said first and second swing arms are supported solely by said post in cantilevered fashion.

2. The bench-top workpiece holder of claim 1 wherein said bench clamp comprises a pair of vertical spaced, substantially parallel plates and a clamp screw.

3-5. (canceled)

6. The bench-top workpiece holder of claim 1 wherein said forked clamp member includes a pair of spaced arms and a clamp screw extending through one of said arms to thereby enable clamping of a workpiece between said clamp screw and the other of said arms.

7. The bench-top workpiece holder of claim 6 wherein a workpiece support block is fixed to the other of said arms.

8-10. (canceled)

11. A bench-top workpiece holder comprising:
a bench clamp comprising a pair of vertically spaced, substantially parallel plates and a clamp screw for attaching the workpiece holder to a bench top; and
an articulated arm assembly supported on a post extending vertically upwardly from said bench clamp, said articulated arm assembly comprising a first substantially horizontal swing arm pivotably mounted on said post and vertically adjustable along the height of said post, a second substantially horizontal swing arm pivotably mounted to a remote end of said first swing arm and a workpiece clamp selectively pivotable about three substantially parallel vertical axes and rotatable about a substantially horizontal axis;
wherein said workpiece clamp assembly comprises a block pivotably secured to a remote end of said second swing arm, and a forked clamp member supported on said block for rotation about said horizontal axis.

12. The bench-top workpiece holder of claim 11 wherein said forked clamp member includes a pair of spaced arms and a clamp screw extending through one of said arms to thereby enable clamping of a workpiece between said clamp screw and the other of said arms.

13. The bench-top workpiece holder of claim 12 wherein a workpiece support block is fixed to the other of said arms.
